(19) United States
(12) Patent Application Publication
(10) Pub. No.: US 2013/0061051 A1
(43) Pub. Date: Mar. 7, 2013

(54) METHOD FOR AUTHENTICATING ELECTRONIC TRANSACTION, SERVER, AND TERMINAL

(71) Applicants: Sung Tae KIM, Seoul (KR); Hak Ryol KIM, Seoul (KR); Kyu Don CHOI, Seoul (KR)

(72) Inventors: Sung Tae KIM, Seoul (KR); Hak Ryol KIM, Seoul (KR); Kyu Don CHOI, Seoul (KR)

(73) Assignee: PANTECH CO., LTD., Seoul (KR)

(21) Appl. No.: 13/563,705

(22) Filed: Jul. 31, 2012

(30) Foreign Application Priority Data
Sep. 7, 2011 (KR) 10-2011-0090697

(51) Int. Cl. H04L 9/32

(52) U.S. Cl. 713/168

(57) ABSTRACT

A method for authenticating an electronic transaction includes: transmitting first authentication data to a first terminal and transmitting second authentication data to a second terminal; receiving first encryption data from the first terminal and receiving second encryption data from the second terminal, the first encryption data corresponding to the first authentication data and the second encryption data corresponding to the second authentication data; storing the first encryption data and the second encryption data; and authenticating the first terminal and the second terminal according to the first authentication data and the second authentication data. The first encryption data is encrypted by a first internal key of the first terminal, and the second encryption data is encrypted by a second internal key of the second terminal.

### CROSS-REFERENCE TO RELATED APPLICATION

This application claims priority from and the benefit under 35 U.S.C. §119(a) of Korean Patent Application No. 10-2011-0090697, filed on Sep. 7, 2011, which is incorporated by reference for all purposed as if fully set forth herein.

### BACKGROUND

1. Field

The present disclosure relates to a method for authenticating an electronic transaction using a short-range wireless communication, a server, and a terminal.

2. Discussion of the Background

Near field communication (NFC) is one of short-range wireless communication methods such as radio frequency identification (RFID) and refers to a technology of transmitting and receiving data between terminals placed at a close distance using a near field wireless communication module using a frequency band of 13.56 MHz.

The NFC technology may provide a user interface for a wireless communication through one contact of two terminals and may process and use data in a desired form. Thus, NFC may be variously used for data communication, such as mobile payments, and the like. NFC may enable compatibility between various apparatuses that conform to the international standard and data synchronization may be possible if terminals providing an NFC function are standardized. Since NFC generally has a communication distance of less than 10 cm, private information may not be easily leaked. Thus, NFC may be used for an application that is sensitive to security issues.

If an NFC function is activated in a terminal, data may be shared between NFC devices using a function for reading a tag or a function for writing a tag. For example, data such as photos, moving images, music files or telephone numbers may be transmitted between NFC devices. Since an NFC communication distance is relatively short, private information leakage may be reduced and fast data communication may be possible.

Thus, NFC technologies may be utilized for various applications, such as payment, entrance management, home appliances, check-in systems, healthcare, information collection, coupons or traffic.

However, it may be difficult to manage personal security certification due to absence of compatibility using existing NFC technologies. In addition, problems may occur in a process of personal security certification or NFC communication due to tapping, illegal data modification, and the like.

Accordingly, a method for authenticating a counterpart of a contract and enhancing personal authentication security may be developed.

### SUMMARY

Exemplary embodiments of the present invention provide a method for authenticating an electronic transaction among multiple terminals using short-range wireless communication such as near field communication (NFC), a server, and a terminal.

Additional features of the invention will be set forth in the description which follows, and in part will be apparent from the description, or may be learned by practice of the invention.

Exemplary embodiment of the present invention provide a method for authenticating an electronic transaction, including transmitting first authentication data to a first terminal and transmitting second authentication data to a second terminal; receiving first encryption data from the first terminal and receiving second encryption data from the second terminal, the first encryption data corresponding to the first authentication data and the second encryption data corresponding to the second authentication data; storing the first encryption data and the second encryption data; and authenticating the first terminal and the second terminal according to the first authentication data and the second authentication data. The first encryption data is encrypted by a first internal key of the first terminal, and the second encryption data is encrypted by a second internal key of the second terminal.

Exemplary embodiments of the present invention provide a server to authenticate an electronic transaction, including a communication unit to transmit first authentication data to a first terminal, to transmit second authentication data to a second terminal, to receive first encryption data from the first terminal, and to receive second encryption data from the second terminal using a first communication method; a data management unit to store the first encryption data and the second encryption data; and an individual authentication unit to authenticate the first terminal and the second terminal according to the first authentication data and the second authentication data. The first encryption data corresponds to the first authentication data and the second encryption data corresponds to the second authentication data, and the first encryption data is encrypted by a first internal key of the first terminal, and the second encryption data is encrypted by a second internal key of the second terminal.

Exemplary embodiments of the present invention provide a terminal to perform an electronic transaction, including a registration unit to receive first authentication data from an authentication server, and to transmit first encryption data to the authentication server, the first encryption data corresponding to the first authentication data; an encryption and decryption unit to encrypt the first authentication data into the first encryption data using a first internal key of the terminal; a communication unit to receive the first authentication data or the first encryption data from a second terminal. The encryption and decryption unit encrypts the first authentication data received from the second terminal, and transmits the encrypted first authentication data to the second terminal if the communication unit receives the first authentication data, and the encryption and decryption unit decrypts the first encryption data received from the second terminal, and transmits the decrypted first encryption data to the second terminal if the communication unit receives the first encryption data.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A is a diagram illustrating a system to authenticate an electronic transaction between two terminals according to an exemplary embodiment of the present invention.

FIG. 1B is a diagram illustrating a system to authenticate an electronic transaction among four terminals according to an exemplary embodiment of the present invention.

FIG. 2 is a flowchart illustrating a method for authenticating an electronic transaction between two terminals according to an exemplary embodiment of the present invention.

FIG. 3 is a block diagram illustrating a server to authenticate an electronic transaction among multiple terminals according to an exemplary embodiment of the present invention.

FIG. 4 is a block diagram illustrating a first terminal to authenticate an electronic transaction according to an exemplary embodiment of the present invention.

FIG. 5 is a block diagram illustrating a second terminal to authenticate an electronic transaction according to an exemplary embodiment of the present invention.

FIG. 6 is a flowchart illustrating a method for authenticating an electronic transaction among three terminals according to an exemplary embodiment of the present invention.

FIG. 7 is a flowchart illustrating a method for authenticating an electronic transaction among three terminals according to an exemplary embodiment of the present invention.

FIG. 8 is a flowchart illustrating a method for authenticating an electronic transaction among four terminals according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one” of will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, XZZ, YZ, X).

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

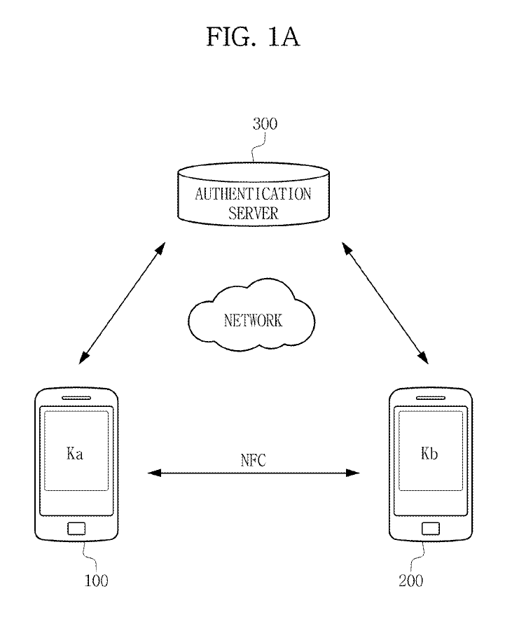

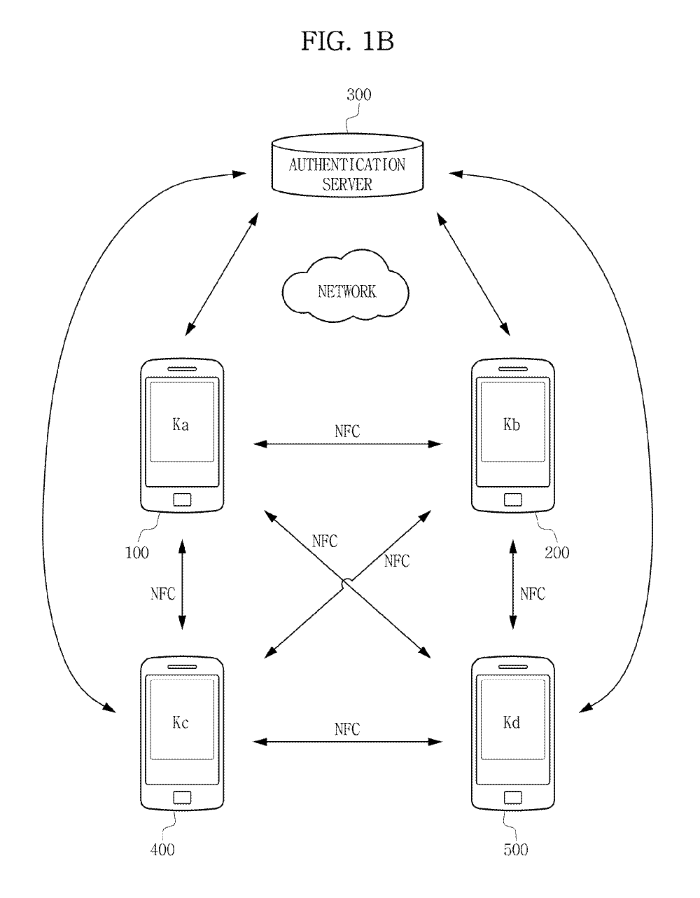

FIG. 1A is a diagram illustrating a system to authenticate an electronic transaction according to an exemplary embodiment of the present invention.

Referring to FIG. 1, the system includes a first terminal 100, a second terminal 200 and a server 300 (an authentication server). A user of the first terminal 100 and a user of the second terminal 200 may request an electronic contract and the authentication server 300 may authenticate the user of the first terminal 100 and the user of the second terminal 200 to complete the electronic transaction, such as an electronic contract, an electronic financial transaction, or the like.

The authentication server 300, the first terminal 100 and the second terminal 200 may include a communication unit to perform wired and/or wireless communication over a corresponding network. Further, the first terminal 100 and the second terminal 200 may include a near field communication module to perform a near field communication (NFC).

The first terminal 100 and the second terminal 200 may include a hardware key having a unique algorithm for encrypting data. The hardware key (“an internal key”) may include a unique hardware characteristic of the terminal. For example, electronic serial number (ESN), international mobile equipment identity (IMEI), and/or user identification module identification (UIM_ID) may be included in the hardware key. For example, the first terminal 100 may include a first hardware key Ka and the second terminal 200 may include a second hardware key Kb. The first hardware key Ka and the second hardware key Kb may not be exposed to outside such as the authentication server 300, an issuing place, and thus may not be copied or leaked.

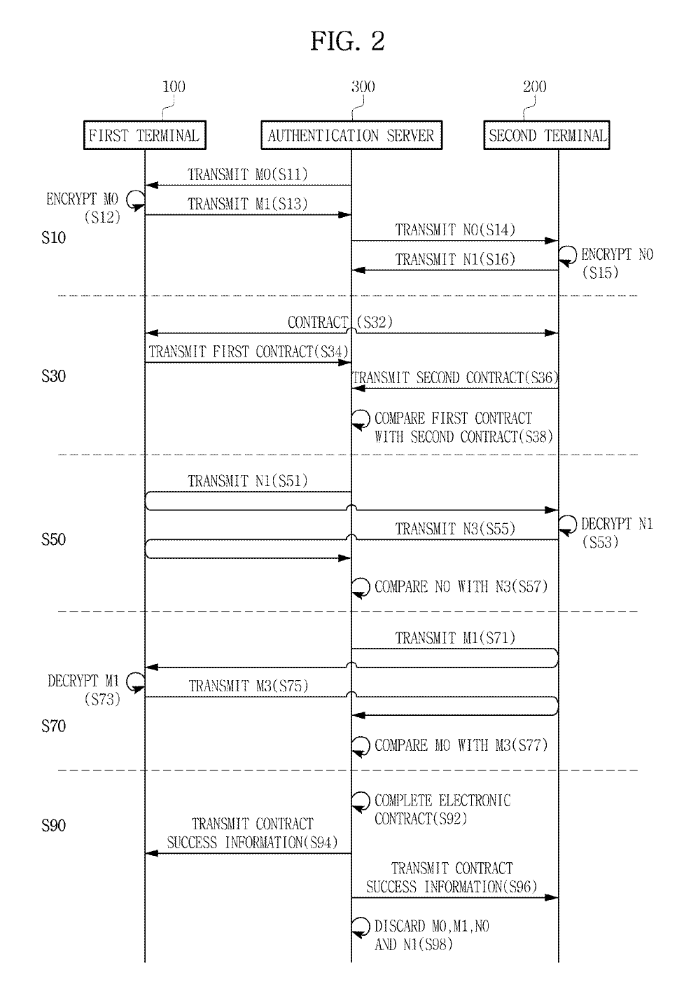

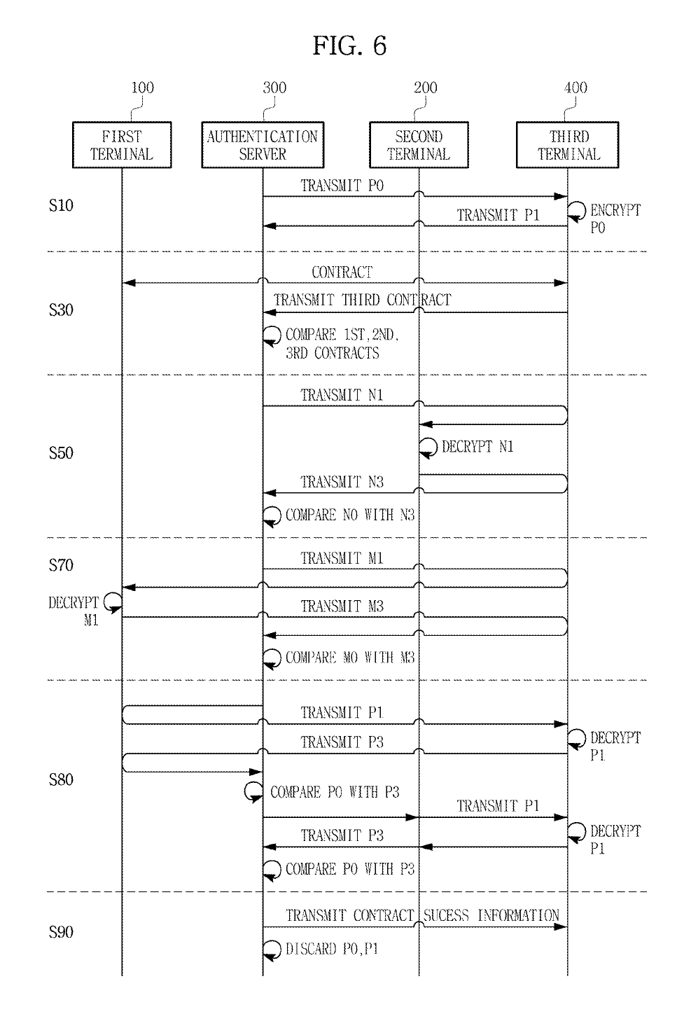

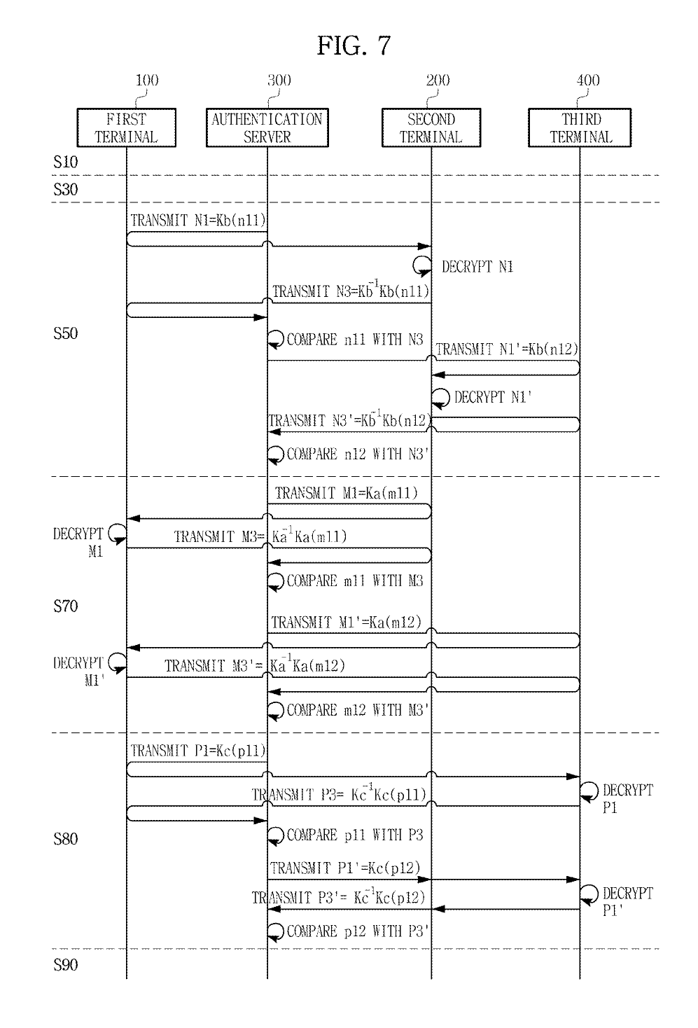

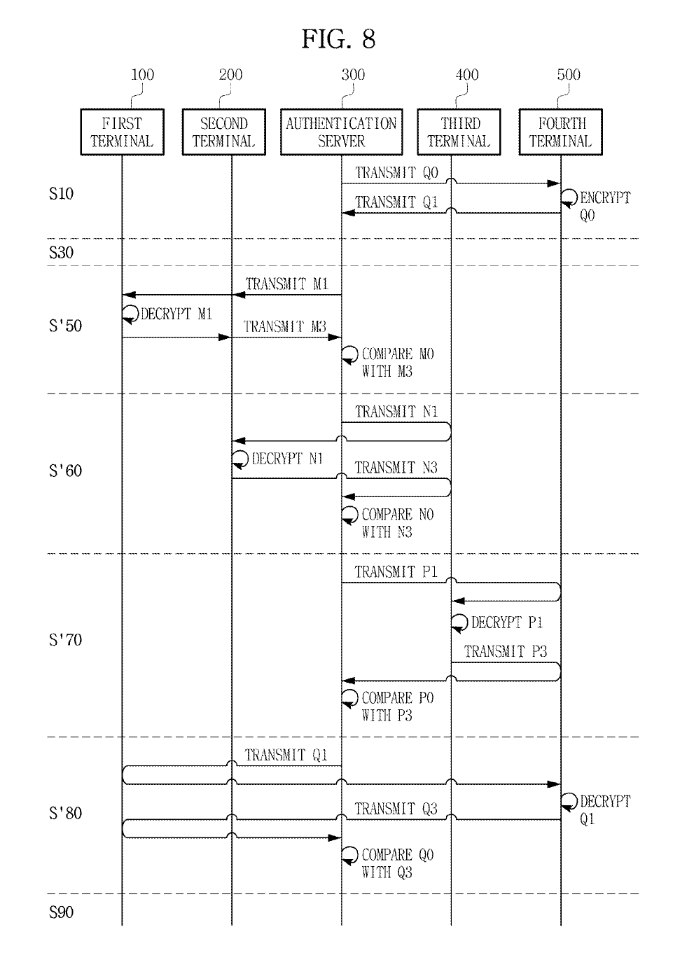

The first terminal 100 and the second terminal 200 may be a mobile terminal that may access the Internet, such as a smart phone, a smart pad, a tablet PC, a PDA or a net book. Although two terminals are illustrated in FIG. 1, three or more terminals may be used for an electronic transaction or an electronic contract among multiple parties. Methods for authenticating an electronic transaction for three of more terminals according to an exemplary embodiment of the present invention will be described in more detail with reference to FIG. 2, FIG. 6, FIG. 7, and FIG. 8.

Hereinafter, the user of the first terminal 100 may be referred to as a first user and the user of the second terminal 200 may be referred to as a second user. The first user and the second user may request an electronic contract to the authentication server 300. For example, the first user of the first terminal 100 and the second user of the second terminal 200 may make a sales contract or a financial transactions contract, and may request authentication of the sales contract or the financial transactions contract to the authentication server 300. Authentication of the first user may be performed by authenticating the first terminal 100 and authentication of the second user may be performed by the second terminal 200. To ensure the authentication of the first user, the first user may register the first terminal 100 to the authentication server 300, and may receive an electronic authentication file used for the electronic transaction and/or a passcode for the electronic transaction in advance. Similarly, to ensure the authentication of the second user, the second user may register the second terminal 200 to the authentication server 300, and may receive an electronic authentication file used for the electronic transaction and/or a passcode for the electronic transaction in advance. The electronic authentication file and/or the passcode of each user may be requested if each user initiates an electronic transaction process using his or her registered terminal.

Hereinafter, a registration process performed by a registration unit (not shown) of a terminal according to an exemplary embodiment of the present invention will be described. The first user and the second user may register setup information, such as personal information including identification and an electronic signature, terminal information of the first terminal, and/or a type of an electronic transaction, to the authentication server 300. The first terminal 100 and the second terminal 200 may transmit setup information of the first user and setup information of the second user, respectively. The setup information of each user may be registered using short-range wireless communication, such as NFC.

The first terminal 100 may receive first authentication data M0 from the authentication server 300 through short-range wireless communication. The first terminal 100 may encrypt the first authentication data M0 into M1=Ka(M0) using an internal hardware key Ka, and transmit M1 to the authentication server 300 through short-range wireless communication. The M0 and M1 may include multiple pieces of data that may be used for once and be discarded after usage. For example, M0=(m11, m12, . . . , m1k) and M1=(Ka(m11), Ka(m12), . . . , Ka(m1k)). The number of pieces ‘k’ may be determined by the first terminal 100 and/or the authentication server 300. Similarly, the second terminal 200 may receive second authentication data N0 from the authentication server 300 through short-range wireless communication. The second terminal 200 may encrypt the second authentication data N0 into N1=Kb(N0) using an internal hardware key Kb, and transmit N1 to the authentication server 300 through short-range wireless communication. The N0 and N1 may include multiple pieces of data that may be used for once and be discarded after usage. For example, N0=(n11, n12, . . . , n1j) and N1=(Kb(n11), Kb(n12), . . . , Kb(n1j)). The number of pieces ‘j’ may be determined by the second terminal 200 and/or the authentication server 300.

FIG. 1B is a diagram illustrating a system to authenticate an electronic transaction among four terminals according to an exemplary embodiment of the present invention. Referring to FIG. 1B, more than two terminals may engage in an electronic transaction. A third terminal 400 having a hardware key Kc and a fourth terminal 500 having a hardware key Kd may communicate with the authentication server 300, respectively. Further, the first, second, third, and fourth terminal 100, 200, 400, and 500 may communicate with each other using short-range wireless communication such as NFC.

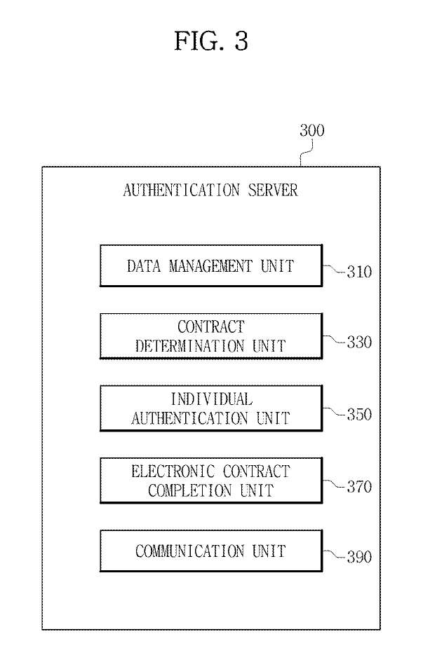

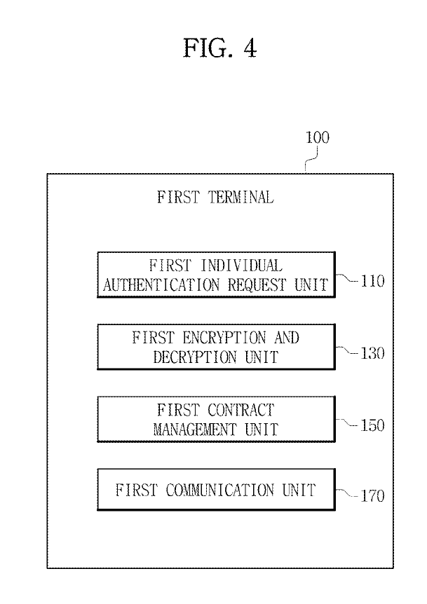

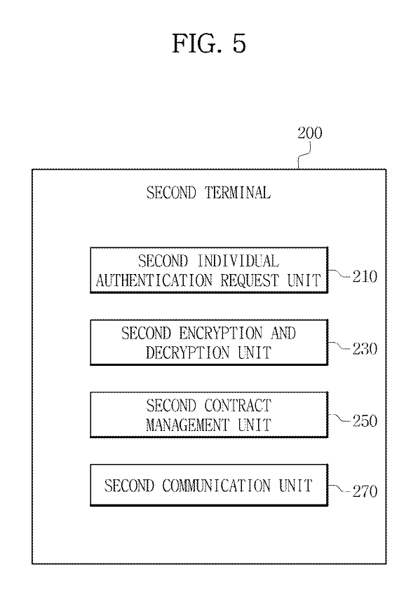

FIG. 2 is a flowchart illustrating a method for authenticating an electronic contract according to an exemplary embodiment of the present invention. FIG. 2 will be described as if performed by authentication server 300, first terminal 100, and second terminal 200 respectively shown in FIG. 3, FIG. 4, and FIG. 5, but is not limited as such.

Referring to FIG. 2, the method may include a step S10 of registering first encryption data generated by a first terminal 100 based on first authentication data and second encryption data generated by a second terminal 200 based on second authentication data, a step S50 of authenticating the second terminal 200 through the first terminal 100 and a step S70 of authenticating the first terminal 100 through the second terminal 200. The communication between the first terminal 100 and the second terminal 200 may be performed through NFC.

The method may further include a step S30 of comparing contracts received from the first terminal 100 and the second terminal 200 to complete the electronic contract and a step S90 of completing the electronic contract.

The step S10 of registering the first encryption data and the second encryption data may include a step of registering the first user and the second user. That is, the first user and the second user may be authenticated through a corresponding organization associated with the contract.

For example, in case of a real estate contract, the organization may be a public organization such as a district office. The public organization may identify the first and second users and store various electronic documents for the contract, such as a resident registration or an authentication certificate of seal.

In case of a financial transactions contract, the organization may be a financial organization such as a bank. The financial organization may identify the first and second users and store a variety of information such as account information, a social security number, or a copy of an identity card.

To register the first encryption data and the second encryption data in step S10, the first user and the second user may be identified through the organization and the authentication of the electronic contract may be requested to the authentication server 300. NFC may be used between the first terminal 100 of the first user and the second terminal 200 of the second user.

The authentication server 300 may transmit authentication data to the first terminal 100 and the second terminal 200. Specifically, the authentication server 300 may generate first authentication data M0 and second authentication data N0. Each of the first authentication data M0 and the second authentication data N0 may include a finite number of randomly generated variables.

The first terminal 100 may encrypt the first authentication data M0 and register the encrypted data to the authentication server 300. The step of registering the first encryption data M1 from the first terminal 100 to the authentication server 300 will be described in more detail. The authentication server 300 may transmit the first authentication data M0=(m11, m12, . . . , m1k) to the first terminal 100 in step S11. The authentication server 300 may store the first authentication data M0.

The first terminal 100 may encrypt the first authentication data M0 using a first hardware key Ka and generate first encryption data M1=(Ka(m11), Ka(m12), . . . , Ka(m1k)) in step S12. The first hardware key Ka may be extracted from the first terminal 100. An encryption algorithm and the first hardware key Ka may not be externally exposed and the user may also be unaware of the algorithm and the first hardware key Ka.

In response to an input of input data, the first hardware key Ka may be used to output encrypted data corresponding to the input data like a black box. Since the encrypted data corresponding to the input data is unique data that is generated using the first hardware key Ka, the encrypted data may be decrypted by the first hardware key Ka of the first terminal 100. The first encryption data M1 may be decrypted into first decrypted data M3 by the first terminal 100 using the first hardware key Ka.

Accordingly, if the first decrypted data M3 acquired by decrypting the first encryption data M1 is received by the authentication server 300, the authentication server 300 may determine that the terminal that decrypts the first encryption data M1 is the first terminal 100 having the first hardware key Ka.

The first terminal 100 may transmit the first encryption data M1 to the authentication server 300 in step S13. The first terminal 100 may store information about the authentication server 300, identification information (ID) of the first user, and/or identification information of the first terminal 100, and the authentication server 300 may receive and register the first encryption data M1.

The authentication server 300 may store the first authentication data M0=(m11, m12, . . . , m1k) and the first encryption data M1=(Ka(m11), Ka(m12), . . . , Ka(m1k)) as a pair to authenticate the first terminal 100.

In the step of registering the second encryption data N1 of the second terminal 200, the authentication server 300 may transmit the second authentication data N0=(n11, n12, . . . , n1j) to the second terminal 200 in step S14. The second terminal 200 may encrypt the second authentication data N0 using the second hardware key Kb and generate the second encryption data N1=(Kb(n11), Kb(n12, . . . , Kb(n1j)) in step S15. The second terminal 200 may transmit the second encryption data N1 to the authentication server 300 in step S16.

The authentication server 300 may receive and register the second encryption data N1. The authentication server 300 may store the second authentication data N0=(n11, n12, . . . , n1j) and the second encryption data N1=(Kb(n11), Kb(n12), . . . , Kb(n1j)) as a pair to authenticate the second terminal 200.

The order of the registration of the first encryption data M1 of the first terminal 100 and the registration of the second encryption data N1 of the second terminal 200 may be changed. Although the registration of the first encryption data M1 of the first terminal 100 is first performed for convenience of description, the registration of the terminal may be performed in a registration request order or the registration of the terminals may be simultaneously performed.

The first encryption data M1 of the first terminal 100 and the second encryption data N1 of the second terminal 200 may be registered in the authentication server 300 and then the first user and the second user may request a certified authentication for a contract in step S32. For example, the contract may be a sales contract or a financial transactions contract in an electronic form. The first user and the second user may meet each other to make a contract or share a contract document through online.

The first user and the second user may create contract documents, a first contract and a second contract, respectively, transmit a first contract and a second contract to the authentication server 300 in step S34 and step S36, and request authentication and/or completion of the contract. The contracts may be transmitted from the first terminal 100 and the second terminal 200 or from other terminals through online.

For example, in case of a real estate contract, the contract may include details such as a rental fee, a deposit, and a rental period. The first contract and the second contract may be transmitted to the authentication server 300 to request authentication and/or completion of the rental contract.

Further, in case of a financial transactions contract, the first contract of a payer may include the amount of money to be paid, payment request account information and a transaction time and the second contract of a payee may include the amount of money to be received, deposit request account information and a transaction time. The first contract and the second contract may be transmitted to the authentication server 300 to request authentication and/or completion of the financial transactions contract.

The authentication server 300 may compare the first contract received from the first terminal 100 with the second contract received from the second terminal 200 if the first user and the second user request to complete the contract in step S38. If the first contract matches, equals or corresponds to the second contract, it may be determined that contractors request to complete the contract and then an individual authentication step may proceed.

The authentication server 300 may crosscheck the contractors to perform authentication. That is, the authentication server 300 may authenticate the second terminal 200 through the first terminal 100 in step S50 and authenticate the first terminal 100 through the second terminal 200 in step S70.

The first terminal 100 and the second terminal 200 may communicate with each other using short-range wireless communication to exchange secured data for authentication. For example, the contractors may meet and bring the first terminal 100 into contact with the second terminal 200 to communicate using NFC. Since NFC has a short communication distance, and may be less than about 10 cm, the NFC may maintain security of the exchanged data. The authentication server 300 may confirm that the contractors meet to make a contract if the steps S50 and S70 are successfully performed.

For authenticating the second terminal 200 in step S50, the authentication server 300 may transmit the second encryption data N1 to the second terminal 200 through the first terminal 100 in step S51. More specifically, the authentication server 300 may transmit the second encryption data N1 to the first terminal 100. The first terminal 100 may transmit the received second encryption data N1 to the second terminal 200 using short-range wireless communication. For example, NFC may be used.

The second terminal 200 may receive the second encryption data N1, decrypt the second encryption data N1, and generate the second decrypted data N3 in step S53. Since the second encryption data N1 is encrypted by the second hardware key Kb, the second encryption data N1 may be decrypted by the second hardware key Kb. Since encryption and decryption processes are performed in the second terminal 200, encryption and decryption algorithms using the second hardware key Kb may not be exposed.

The second terminal 200 may transmit the second decrypted data N3 to the authentication server 300 through the first terminal 100 in step S55. More specifically, the second terminal 200 may transmit the second decrypted data N3 to the first terminal 100 using short-range wireless communication, for example, NFC may be used. The first terminal 100 may transmit the received second decrypted data N3 to the authentication server 300.

The authentication server 300 may compare the second decrypted data N3, which is acquired in response to a provision of the second encryption data N1 through the first terminal 100, with the second authentication data N0 corresponding to the second encryption data N1 in step S57. If the second decrypted data N3 equals to or corresponds to the second authentication data N0, the authentication server 300 may authenticates that the counterpart of the first terminal 100 is the second terminal 200.

The method for authenticating the first terminal 100 in step S70 is similar to the method for authenticating the second terminal 200 in step S50. The authentication server 300 may transmit the first encryption data M1 to the first terminal 100 through the second terminal 200 in step S71.

The first terminal 100 may receive the first encryption data M1, decrypt the first encryption data M1, and generate the first decrypted data M3 in step S73. Since the first encryption data M1 is encrypted by the first hardware key Ka, the first encryption data M1 may be decrypted by the first hardware key Ka. The first terminal 100 may transmit the first decrypted data M3 to the authentication server 300 through the second terminal 200 in step S75. Communications between the first terminal 100 and the second terminal 200 may be performed using short-range wireless communication, such as NFC. Since encryption and decryption processes are performed in the first terminal 100, encryption and decryption algorithms using the first hardware key Ka may not be exposed.

The authentication server 300 may compare the first decrypted data M3, which is acquired in response to a provision of the first encryption data M1 through the second terminal 200, with the first authentication data M0 corresponding to the first encryption data M1 in step S77. If the first decrypted data M3 equals to or corresponds to the first authentication data M0, the authentication server 300 may authenticates that the counterpart of the second terminal 200 is the first terminal 100.

Although it is described that the step S50 of authenticating the second terminal 200 is performed before the step S70, the step S70 of authenticating the first terminal 100 may be performed before the step S50 or the step S50 of authenticating the second terminal 200 and the step S70 of authenticating the first terminal 100 may be simultaneously performed. Further, only one of step S50 or step S70 may be performed, or both steps may be omitted.

As described above, if it is authenticated that the counterpart of the first terminal 100 is the second terminal 200 and the counterpart of the second terminal 200 is the first terminal 100, the authentication server 300 may determine whether the contractors agree the contract.

The authentication server 300 may authenticate and/or complete the electronic contract requested by the contractors in step S90.

For example, in case of a real estate contract, the authentication sever 300 of the public organization may add various previously registered contract documents such as a resident registration or an authentication certificate and generate the electronic contract in step S92. Further, a fixed date or a seal of the public organization may be added to the electronic contract to authenticate, certify, or formalize the contract. The generated electronic contract may be transmitted to the first terminal 100 and the second terminal 200 in step S94 and step S96, respectively.

Further, in case of a financial transactions contract, the authentication server of the financial organization may carry on financial transactions requested by the first terminal 100 and the second terminal 200 in step S92 and transmit the result to the first terminal 100 and the second terminal in step S94 and step S96, respectively.

If the electronic contract is completed in step S92, the authentication server 300 may discard used authentication data for security. For example, the first authentication data M0, the first encryption data M1, the second authentication data N0 and the second encryption data N1 may be discarded in step S98.

Specifically, if individual authentication is requested again, the authentication server 300 may generate first renewed authentication data M0=(m21, m22, . . . , m2k) and second renewed authentication data N0=(n21, n22, . . . , n2j). The first hardware key Ka and the second hardware key Kb may generate first renewed encryption data M1=(Ka(m21, Ka(m22), . . . , Ka(m2k)) and second renewed encryption data N1=(Kb(n21), Kb(n22), . . . , Kb(n2j)) respectively corresponding to the first renewed authentication data M0=(m21, m22, . . . , m2k) and the second renewed authentication data N0=(n21, n22, . . . , n2j). For the renewal of the first renewed authentication data and the first renewed encryption data, the authentication server 300 may authenticate the first terminal 100 using the first authentication data M0 and the first encryption data M1.

In an example, for re-authentications for the first terminal 100 and the second terminal 200, (m12, . . . , m1k), (Ka(m12), . . . , Ka(m1k)), (n12, . . . , n1j), and (Kb(n12), . . . , Kb(n1j)) may be preserved when m11, Ka(m11), n11, and Kb(n11) are discarded after terminating the authentication processes for completing the electronic contract by using the m11, Ka(m11), n11, and Kb(n11). In this case, for the renewal of the first renewed authentication data and the first renewed encryption data, the authentication server 300 may authenticate the first terminal 100 using one of the remaining pieces of the first authentication data and a corresponding one of the remaining pieces of the first encryption data M1. For example, m1k and Ka(m1k) may be used for the renewal of the first authentication data M0 and the first encryption data M1.

If the electronic contract is completed in step S92, the authentication server 300 may compute and store a checksum of the completed electronic contract. If the contract document is changed, the checksum may be changed. Thus, the checksum may be used to verify whether the contract document is genuine. The electronic contract document may include an authentication signature and a checksum block. The checksum block may be included in the authentication signature.

The method may provide a secured authentication process to authenticate the contract counterpart in the electronic contract using NFC. In addition, since an authentication organization having public confidence participates in the contract, it may be possible to provide a one-stop electronic contract. Further, it may be possible to prevent the contract document from being changed after the electronic contract is completed and the contract document may be verified.

FIG. 3 is a block diagram illustrating a server to authenticate an electronic transaction among multiple terminals according to an exemplary embodiment of the present invention.

Referring to FIG. 3, the authentication server 300 includes a data management unit 310, an individual authentication unit 350 and a communication unit 390. The authentication server 300 may further include a contract determination unit 330 and an electronic contract completion unit 370 to complete the electronic contract. Hereinafter, the repeated description of the method for authenticating the electronic contract of FIG. 2 will be briefly described or omitted.

The data management unit 310 may generate the first authentication data M0 including a finite number of randomly generated variables and the second authentication data N0 including a finite number of randomly generated variables and respectively transmit the first authentication data M0 and the second authentication data N0 to the first terminal 100 and the second terminal 200.

The data management unit 310 may receive the first encryption data M1 and the second encryption data N1 obtained by encrypting the first authentication data M0 and the second authentication data N0 from the first terminal 100 and the second terminal 200, respectively. The data management unit 310 may store the first authentication data M0 and the first encryption data M1 corresponding to the first authentication data M0 as a pair and store the second authentication data N0 and the second encryption data N1 corresponding the second authentication data N0 as a pair.

The individual authentication unit 350 may provide the second encryption data N1 through the first terminal 100 to authenticate the second terminal 200 and provide the first encryption data M1 through the second terminal 200 to authenticate the first terminal 100.

More specifically, the individual authentication unit 350 may provide the second encryption data N1 to the second terminal 200 through the first terminal 100 to authenticate the second terminal 200. The second terminal 200 may generate the second decrypted data N3 obtained by decrypting the second encryption data N1 and send the second decrypted data N3 to the individual authentication unit 350 through the first terminal 100.

The individual authentication unit 350 may compare the second decrypted data N3 with the second authentication data N0 and authenticate that the counterpart of the first terminal 100 is the second terminal 200 if the second decrypted data N3 equals to or corresponds to the second authentication data N0.

Similarly, the individual authentication unit 350 may provide the first encryption data M1 to the first terminal 100 through the second terminal 200 to authenticate the first terminal 100. The first terminal 100 may generate the first decrypted data M3 obtained by decrypting the first encryption data M1 and send the first decrypted data M3 to the individual authentication unit 350 through the second terminal 200.

The individual authentication unit 350 may compare the first decrypted data M3 with the first authentication data M0 and authenticate that the counterpart of the second terminal 200 is the first terminal 100 if the first decrypted data M3 equals to or corresponds to the first authentication data M0.

The communication unit 390 may perform short-range wireless communication, such as NFC, with the first terminal 100 and/or the second terminal 200 and perform wired/wireless communication over a network. For example, the data management unit 310 may use NFC and the individual authentication unit 350 may use wireless communication over a network.

The contract determination unit 330 may compare the first contract provided by the first terminal 100 with the second contract provided by the second terminal 200 to determine whether the first contract equals to or corresponds to the second contract.

The electronic contract completion unit 370 may attach previously registered information used for the contract and complete the electronic contact, if the first terminal 100 and the second terminal 200 are successfully authenticated. The electronic contract completion unit 370 may include a checksum unit (not shown) for checking a checksum to prevent the completed electronic contract from being changed or to verify the electronic contract.

If the contract is completed, the data management unit 310 may discard data used for security, that is, m11 of the first authentication data M0, Ka(m11) of the first encryption data M1, n11 of the second authentication data N0, and Kb(n11) of the second encryption data N1. If individual authentication is requested again for the same electronic contract, the data management unit 310 may use first authentication data M0=(m21, m22, . . . , m2k) and second authentication data N0=(n21, n22, . . . , n2j).

The authentication server 300 may be a server of an authorized organization associated with the electronic contract. For example, in case of a real estate contract, the organization may be a public organization such as a district office. In case of a financial transactions contract, the organization may be a financial organization such as a bank. Further, in case of a direct transactions contract between individuals, the organization may be a market or shopping mall of the Internet.

The contractors may be identified by the authentication server 300 before completing the contract and authenticate the counterpart of the contract in the electronic contract. In addition, since a procedure for the electronic contract is unified in a system, it is possible to conveniently or safely close the electronic contract.

One or more operations of the data management unit 310, the contract determination unit 330, the individual authentication unit 350, the electronic contract completion unit 370, and the communication unit 390 may be performed by another unit among the data management unit 310, the contract determination unit 330, the individual authentication unit 350, the electronic contract completion unit 370, and the communication unit 390. Further, a portion of or all the operations of the data management unit 310, the contract determination unit 330, the individual authentication unit 350, the electronic contract completion unit 370, and the communication unit 390 may be performed by one or more processors included in the authentication server 300.

FIG. 4 is a block diagram illustrating a first terminal to authenticate an electronic transaction according to an exemplary embodiment of the present invention.

Referring to FIG. 4, the first terminal 100 includes a first individual authentication request unit 110, a first encryption and decryption unit 130, a first contract management unit 150 and a first communication unit 170. The first communication unit 170 may include a first registration unit (not shown).

The first individual authentication request unit 110 may request the first authentication data M0 from the authentication server 300. The first authentication data M0 may be used to authenticate the first terminal 100. Further, the first individual authentication request unit 110 may request the second encryption data N1 for authenticating the second terminal 200 which is a counterpart of the electronic contract from the authentication server 300.

The first encryption and decryption unit 130 may include the unique first hardware key Ka for encrypting data. The first encryption and decryption unit 130 may encrypt the first authentication data M0 received from the authentication server 300 using the first hardware key Ka and generate the first encryption data M1=(Ka(m11), Ka(m12), . . . , Ka(m1k)).

The first encryption data M1 may be stored in the authentication server 300 and may be provided to the first encryption and decryption unit 130 through the second terminal 200. The first encryption and decryption unit 130 may decrypt the first encryption data M1 and generate the first decrypted data M3. The first decrypted data M3 may be transmitted to the authentication server 300 through the second terminal 200.

The first contract management unit 150 may generate and store the contract (i.e., electronic contract document). The first contract management unit 150 may download the contract from another terminal or a server through wired/wireless communication or NFC. The first contract management unit 150 may revise and update the contract by the control of the user.

The first communication unit 170 may perform short-range wireless communication such as NFC with the authentication server 300 and/or the second terminal 200 and perform wired/wireless communication over a network. The first communication unit 170 may authenticate the second terminal 200 which is the contract counterpart of the first terminal 100 using NFC.

More specifically, if the first individual authentication request unit 110 requests the second encryption data N1 from the authentication server 300 to authenticate the second terminal 200, the first communication unit 170 may receive the second encryption data N1 from the authentication server 300.

The first communication unit 170 may send the second encryption data N1 to the second terminal 200 using short-range wireless communication such as NFC and receive the second decrypted data N3 from the second terminal 200 using short-range wireless communication. The second terminal 200 may obtain the second decrypted data N3 by decrypting the second encryption data N1. Subsequently, the first communication unit 170 may send the second decrypted data N3 to the authentication server 300.

The authentication server 300 may authenticate that the counterpart of the first terminal 100 is the second terminal 200 if the second decrypted data N3 equals to or corresponds to the second authentication data N0.

One or more operations of the first individual authentication request unit 110, the first encryption and decryption unit 130, the first contract management unit 150 and the first communication unit 170 may be performed by another unit among the first individual authentication request unit 110, the first encryption and decryption unit 130, the first contract management unit 150 and the first communication unit 170. Further, a portion of or all the operations of the first individual authentication request unit 110, the first encryption and decryption unit 130, the first contract management unit 150 and the first communication unit 170 may be performed by one or more processors included in the first terminal 100.

FIG. 5 is a block diagram illustrating a second terminal for authenticating an electronic transaction according to an exemplary embodiment of the present invention. Referring to FIG. 5, the second terminal 200 includes a second individual authentication request unit 210, a second encryption and decryption unit 230, a second contract management unit 250 and a second communication unit 270. The second communication unit 270 may include a second registration unit (not shown).

The second individual authentication request unit 210 may request the second authentication data N0 from the authentication server 300. The second authentication data N0 may be used to authenticate the second terminal 200. Further, the second individual authentication request unit 210 may request the first encryption data M1 for authenticating the first terminal 100 which is a counterpart of the electronic contract from the authentication server 300.

The second encryption and decryption unit 230 may include the unique second hardware key Kb for encrypting data. The second encryption and decryption unit 230 may encrypt the second authentication data N0 received from the authentication server 300 using the second hardware key Kb and generate the second encryption data N1=(Kb(n11), Kb(n12), . . . , Kb(n1j)).

The second encryption data N1 may be stored in the authentication server 300 and may be provided to the second encryption and decryption unit 230 through the first terminal 100. The second encryption and decryption unit 230 may decrypt the second encryption data N1 and generate the second decrypted data N3. The second decrypted data N3 may be transmitted to the authentication server 300 through the first terminal 100.

The second contract management unit 250 may generate and store the contract (i.e., electronic contract document). The second contract management unit 250 may download the contract from another terminal or a server through wired/wireless communication or NFC. The second contract management unit 250 may revise and update the contract by the control of the user.

The second communication unit 270 may perform short-range wireless communication such as NFC with the authentication server 300 and/or the first terminal 100 and perform wired/wireless communication over a network. The second communication unit 270 may authenticate the first terminal 100 which is the contract counterpart of the second terminal 200 using NFC.

More specifically, if the second individual authentication request unit 210 requests the first encryption data M1 from the authentication server 300 to authenticate the first terminal 100, the second communication unit 270 may receive the first encryption data M1 from the authentication server 300.

The second communication unit 270 may send the first encryption data M1 to the first terminal 100 using short-range wireless communication such as NFC and receive the first decrypted data M3 from the first terminal 100 using short-range wireless communication. The first terminal 100 may obtain the first decrypted data M3 by decrypting the first encryption data M1. Subsequently, the second communication unit 270 may send the first decrypted data M3 to the authentication server 300.

The authentication server 300 may authenticate that the counterpart of the second terminal 200 is the first terminal 100 if the first decrypted data M3 equals to or corresponds to the first authentication data M0.

One or more operations of the second individual authentication request unit 210, the second encryption and decryption unit 230, the second contract management unit 250 and the second communication unit 270 may be performed by another unit among the second individual authentication request unit 210, the second encryption and decryption unit 230, the second contract management unit 250 and the second communication unit 270. Further, a portion of or all the operations of the second individual authentication request unit 210, the second encryption and decryption unit 230, the second contract management unit 250 and the second communication unit 270 may be performed by one or more processors included in the second terminal 200.

FIG. 6 is a flowchart illustrating a method for authenticating an electronic transaction among three terminals according to an exemplary embodiment of the present invention.

Referring back to FIG. 2 and FIG. 6, if more than two terminals engage in an electronic transaction, for example, the first terminal 100, the second terminal 200, and a third terminal 400, the authentication server 300 may transmit P0=(p11, p12, . . . , p1i) to the third terminal 400. The third terminal 400 may encrypt the P0 using a hardware key Kc and transmit P1=(Kc(p11), Kc(p12), . . . , Kc(p1i)) to the authentication server 300. The third terminal 400 may transmit a third contract to the authentication server 300 and the third contract may be compared with the first contract and/or the second contract. For authenticating the first terminal 100, the authentication server 300 may transmit M1 to the second terminal 200 and the third terminal 400, as shown in FIG. 2 and FIG. 6 respectively. If there are more than three terminals engaged in the electronic transaction, M1 may also be transmitted to the other terminals. The second terminal 200 and the third terminal 400 may transmit M1 to the first terminal 100, respectively, and may receive M3 from the first terminal 100, as shown in FIG. 2 and FIG. 6 respectively. M3 may be transmitted to the authentication server 300 from the second terminal 200 and the third terminal 400. Contract success information may be transmitted to the third terminal 400 if the electronic transaction (electronic contract) is completed.

Further, in step 80, authentication server 300 may transmit P1 to the first terminal 100, and the first terminal 100 may transmit P1 to the third terminal 400. The third terminal 400 may decrypt P1 and transmit P3 to the first terminal 100. The first terminal 100 may transmit P3 to the authentication server 300, and the authentication server 300 may compare P0 with P3. Authentication server 300 may transmit P1 to the second terminal 200, and the second terminal 200 may transmit P1 to the third terminal 400. The third terminal 400 may decrypt P1 and transmit P3 to the second terminal 200. The second terminal 200 may transmit P3 to the authentication server 300, and the authentication server 300 may compare P0 with P3. In step 90, the authentication server 300 may discard P0 and/or P1.

FIG. 7 is a flowchart illustrating a method for authenticating an electronic transaction among three terminals according to an exemplary embodiment of the present invention. Steps S50 and S70 in FIG. 7 replace steps S50 and S70 in FIG. 2, respectively.

Referring to FIG. 2 and FIG. 7, in step S70, M1=Ka(m11) and M′1=Ka(m12) may be transmitted to the second terminal 200 and the third terminal 400, respectively. In this case, the first terminal 100 may receive Ka(m11) from the second terminal 200, and transmit M3=Ka⁻¹(Ka(m11)) to the second terminal 200. M3=Ka⁻¹ Ka(m11) is a decryption of Ka(m11) using the hardware key Ka. The second terminal 200 may transmit the M3=Ka⁻¹(Ka(m11)) to the authentication server 300. Similarly, the first terminal 100 may receive Ka(m12) from the third terminal 400, and transmit M′3=Ka⁻¹(Ka(m12)) to the third terminal 400. M′3=Ka⁻¹ Ka(m12) is a decryption of Ka(m12) using the hardware key Ka. The third terminal 400 may transmit the M′3=Ka⁻¹(Ka(m12)) to the authentication server 300.

Similarly, in step S50 in FIG. 7, N1=Kb(n11) and N′1=Kb(n12) may be transmitted to the first terminal 100 and the third terminal 400, respectively. In this case, the second terminal 200 may receive Kb(n11) from the first terminal 100, and transmit N3=Kb⁻¹(Kb(n11) to the first terminal 100. N3=Kb⁻¹ Kb(n11) is a decryption of Kb(n11) using the hardware key Kb. The first terminal 100 may transmit the N3=Kb⁻¹(Kb(n11)) to the authentication server 300. Similarly, the second terminal 200 may receive Kb(n12) from the third terminal 400, and transmit N′3=Kb⁻¹(Kb(n12)) to the third terminal 400. N′3=Kb⁻¹ Kb(n12) is a decryption of Kb(n12) using the hardware key Kb. The third terminal 400 may transmit the N′3=Kb⁻¹(Kb(n12)) to the authentication server 300.

In step S80 in FIG. 7, P1=Kc(p11) and P′1=Kc(p12) may be transmitted to the first terminal 100 and the second terminal 200, respectively. In this case, the third terminal 400 may receive Kc(p11) from the first terminal 100, and transmit P3=Kc⁻¹(Kc(p11)) to the first terminal 100. P3=Kc⁻¹ Kc(p11) is a decryption of Kc(p11) using the hardware key Kc. The first terminal 100 may transmit the P3=Kc⁻¹(Kc(p11)) to the authentication server 300. Similarly, the third terminal 400 may receive Kc(p12) from the second terminal 200, and transmit P′3=Kc⁻¹(Kc(p12)) to the second terminal 200. P′3=Kc⁻¹ Kc(p12) is a decryption of Kc(p12) using the hardware key Kc. The second terminal 200 may transmit the P′3=Kc⁻¹(Kc(p12)) to the authentication server 300.

FIG. 8 is a flowchart illustrating a method for authenticating an electronic transaction among four terminals according to an exemplary embodiment of the present invention.

Referring to FIG. 2 and FIG. 8, authentication of the first terminal 100 may be performed through the second terminal 200, authentication of the second terminal 200 may be performed through the third terminal 400, authentication of the third terminal 400 may be performed through a fourth terminal 500, and authentication of the fourth terminal 500 may be performed through the first terminal 100. In this authentication process, each terminal may communicate with two other terminals without communicating with all the other terminals for the authentication process.

Since the contractors of the electronic contract may mutually authenticate the counterparts of the electronic contract using the terminals of the contractors, it may be possible to conveniently and safely make the electronic contract. The terminals may be pre-registered to an authentication server of the public organization.

As described above, according to the method for authenticating the electronic contract and the authentication server and terminal for authenticating the electronic contract, it may be possible to enhance individual authentication security using short-range wireless communication such as NFC. Since the contractors mutually crosscheck the counterparts of the electronic contract through the terminals of each contractor to perform authentication, it may be possible to conveniently or safely authenticate the counterpart of the electronic contract.

In addition, since individual authentication is performed through an authentication organization, it may be possible to safely make an electronic contract.

Accordingly, the method for authenticating the electronic contract and the authentication server and terminal for authenticating the electronic contract may be applicable to various types of contracts such as a real estate contract, a liquid asset contract and a financial transactions contract, electronic payment, entrance management, traffic, ticketing, or the like.

Further, since a unique hardware key is not externally exposed when multiple terminals perform data communication, it may be possible to enhance individual authentication security. In addition, since an electronic contract is unified through a reliable authentication organization, it may be possible to conveniently make the electronic transaction. Further, since the checksum of the electronic contract is checked after the contract is completed, it may be possible to prevent the electronic transaction from being changed.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for authenticating an electronic transaction, comprising:
transmitting first authentication data to a first terminal and transmitting second authentication data to a second terminal;
receiving first encryption data from the first terminal and receiving second encryption data from the second terminal, the first encryption data corresponding to the first authentication data and the second encryption data corresponding to the second authentication data;
storing the first encryption data and the second encryption data; and
authenticating the first terminal and the second terminal according to the first authentication data and the second authentication data,
wherein the first encryption data is encrypted by a first internal key of the first terminal, and the second encryption data is encrypted by a second internal key of the second terminal.

2. The method of claim 1, wherein
the first internal key comprises a first algorithm in association with the first terminal, and
the second internal key comprises a second algorithm in association with the second terminal.

3. The method of claim 1, wherein
the first internal key encrypts data based on a first identification number of the first terminal, and
the second internal key encrypts data based on a second identification number of the second terminal.

4. The method of claim 3, wherein the first identification number and the second identification number comprise at least one of an electronic serial number, international mobile equipment identity, and a user identification module identification.

5. The method of claim 1, wherein receiving of the first encryption data or receiving of the second encryption data is performed using near field communication (NFC).

6. The method of claim 1, further comprising:
receiving a request to authenticate the electronic transaction;
retransmitting the first authentication data in response to the request to authenticate the electronic transaction;
receiving third encryption data in response to the retransmission of the first authentication data; and
authenticating the first terminal if the first encryption data corresponds to the third encryption data.

7. The method of claim 1, further comprising:
receiving a request to authenticate the electronic transaction;
transmitting the first encryption data;
receiving a first decryption data in response to the transmission of the first encryption data; and
authenticating the first terminal if the first decryption data corresponds to the first authentication data.

8. The method of claim 7, further comprising:
transmitting the second encryption data to the first terminal;
receiving a second decryption data from the first terminal in response to the transmission of the second encryption data; and
authenticating the second terminal as a counterpart of the first terminal if the second decryption data corresponds to the second authentication data,
wherein the first encryption data is transmitted to the second terminal,
the first decryption data is received from the second terminal, and
the first terminal is authenticated as a counterpart of the second terminal if the first decryption data corresponds to the first authentication data.

9. The method of claim 7, further comprising generating an authenticated electronic document comprising a checksum block if the first terminal and the second terminal are successfully authenticated.

10. The method of claim 7, further comprising discarding at least one of the first authentication data and the first encryption data.

11. A server to authenticate an electronic transaction, comprising:
a communication unit to transmit first authentication data to a first terminal, to transmit second authentication data to a second terminal, to receive first encryption data from the first terminal, and to receive second encryption data from the second terminal;
a data management unit to store the first encryption data and the second encryption data; and
an individual authentication unit to authenticate the first terminal and the second terminal according to the first authentication data and the second authentication data,
wherein the first encryption data corresponds to the first authentication data and the second encryption data corresponds to the second authentication data, and
wherein the first encryption data is encrypted by a first internal key of the first terminal, and the second encryption data is encrypted by a second internal key of the second terminal.

12. The server of claim 11, wherein the communication unit transmits and receives data using near field communication (NFC).

13. The server of claim 11, further comprising an individual authentication unit to authenticate the first terminal if third encryption data received from the second terminal corresponds to the first encryption data,
wherein the communication unit receives a request to authenticate the electronic transaction, transmits the first authentication data to the second terminal, and receives the third encryption data in response to the transmission of the first authentication data to the second terminal.

14. The server of claim 11, further comprising an individual authentication unit to authenticate the first terminal if a first decryption data corresponds to the first authentication data,
wherein the communication unit receives a request to authenticate the electronic transaction, transmits the first encryption data, and receives the first decryption data in response to the transmission of the first encryption data.

15. The server of claim 14, wherein the communication unit
transmits the second encryption data to the first terminal;
receives a second decryption data from the first terminal in response to the transmission of the second encryption data; and
authenticates the second terminal as a counterpart of the first terminal if the second decryption data corresponds to the second authentication data,
wherein the first encryption data is transmitted to the second terminal,
the first decryption data is received from the second terminal, and
the first terminal is authenticated as a counterpart of the second terminal if the first decryption data corresponds to the first authentication data.

16. The server of claim 14, further comprising an electronic transaction completion unit to generate an authenticated electronic document comprising a checksum block if the first terminal and the second terminal are successfully authenticated.

17. The server of claim 14, wherein the data management unit discards at least one of the first authentication data and the first encryption data.

18. A terminal to perform an electronic transaction, comprising:
a registration unit to receive first authentication data from an authentication server, and to transmit first encryption data to the authentication server, the first encryption data corresponding to the first authentication data;
an encryption and decryption unit to encrypt the first authentication data into the first encryption data using a first internal key of the terminal;
a communication unit to receive the first authentication data or the first encryption data from a second terminal,
wherein the encryption and decryption unit encrypts the first authentication data received from the second terminal, and transmits the encrypted first authentication data to the second terminal if the communication unit receives the first authentication data, and
wherein the encryption and decryption unit decrypts the first encryption data received from the second terminal, and transmits the decrypted first encryption data to the second terminal if the communication unit receives the first encryption data.

19. The terminal of claim 18, further comprising an individual authentication request unit to request an authentication of the electronic transaction among one or more other terminals.

20. The terminal of claim 18, wherein the communication unit receives an authenticated electronic document from the authentication server, if the encrypted first authentication data corresponds to the first encrypted data stored in the authentication server or the decrypted first encryption data corresponds to the first authentication data stored in the authentication server.

21. The terminal of claim 18, wherein the communication unit receives a second authentication data or a second encryption data from the authentication server and transmits the second authentication data or the second encryption data to the second terminal.

22. The terminal of claim 21, wherein the communication unit receives a second encryption data from the second terminal and transmits the second encryption data to the authentication server, if the communication unit transmits the second authentication data to the second terminal, and
wherein the communication unit receives a second authentication data from the second terminal and transmits the second authentication data to the authentication server, if the communication unit transmits the second encryption data to the second terminal.

23. The terminal of claim 18, wherein the first internal key comprises a first algorithm in association with the first terminal.

24. The terminal of claim 18, wherein the first internal key encrypts data based on a first identification number of the first terminal.

25. The terminal of claim 24, wherein the first identification number comprises at least one of an electronic serial number, international mobile equipment identity, and a user identification module identification.

26. The terminal of claim 18, wherein the terminal transmits the first encryption data to the authentication server using near field communication (NFC).
